(19) United States
(12) Patent Application Publication
(10) Pub. No.: US 2025/0116948 A1
(43) Pub. Date: Apr. 10, 2025

(54) TONER

(71) Applicant: CANON KABUSHIKI KAISHA, Tokyo (JP)

(72) Inventors: MARI KABURAGI, Chiba (JP); ICHIRO KANNO, Chiba (JP); TORU TAKAHASHI, Ibaraki (JP); RYUICHIRO MATSUO, Ibaraki (JP); HITOSHI SANO, Chiba (JP); HAYATO IDA, Ibaraki (JP); YUYA CHIMOTO, Chiba (JP)

(21) Appl. No.: 18/906,767

(22) Filed: Oct. 4, 2024

(30) Foreign Application Priority Data
Oct. 6, 2023 (JP) 2023-173999

(51) Int. Cl. G03G 9/093; G03G 9/08

(52) U.S. Cl. CPC G03G 9/09342; G03G 9/0819; G03G 9/0821; G03G 9/09371

(57) ABSTRACT

A toner including a toner particle, a composite particle present on a surface of the toner particle, and a spherical silica fine particle. The composite particle includes a fine particle A containing an organic silicon compound as a binder component, and a fine particle B which is an inorganic fine particle. The fine particle B is present on a surface of the composite particle in a state where a part of the fine particle B is embedded in a surface of the fine particle A. The composite particle and the silica fine particle each have a predetermined particle diameter, proportions of bifunctional to tetrafunctional silicon atoms in the fine particle A satisfy predetermined requirements, and an average value of embedding ratios of the fine particle B to the fine particle A in the composite particle is 30% or greater and 90% or less.

### BACKGROUND

### Field

The present disclosure relates to a toner used for an electrophotographic method and a two-component developer formed of the toner.

### Description of the Related Art

In recent years, with the widespread use of an electrophotographic full-color copying machine, there has been a demand for further improving the image quality and stably outputting a high-quality image even in long-term use. Dot reproducibility is required to be improved in order to improve the image quality of the toner, and formation of dense dots in the development is required so that dot collapse does not occur in a transferring step.

As a method of improving the dot reproducibility of the toner, a method of coating toner particles with spherical silica fine particles to decrease the adhesion force of the toner so that the developability and the transferability are enhanced is known (Japanese Patent Laid-Open Nos. H5-72801 and H8-220874).

Further, a method of adding fine particles in a shape in which a plurality of metal oxide particles are embedded in a polymer matrix (base particle) and protrude outward (hereinafter, also referred to as a confetti shape) to a surface of a toner as an external additive to suppress desorption of the external additive from the toner is known (Japanese Patent No. 5982003).

As described in Japanese Patent Laid-Open Nos. H5-72801 and H8-220874, the developability and the transferability of the toner are increased and the dot reproducibility is also improved by externally adding spherical silica, but a disadvantage in that in a case where media with a highly uneven surface, such as rough paper, are used, the pressure is concentrated on protrusions during transfer, and as a result, dots are collapsed occurs when this method is used.

In a case where the confetti-shaped particles as described in Japanese Patent No. 5982003 are used as an external additive in order to deal with the above-described disadvantage, confetti-shaped protrusions bite into the toner due to the pressure during the transfer so that the adhesion force between toner particles is increased, and thus suppression of dot collapse can be expected. However, since the adhesion force between the toner particles is increased as compared with a case where a spherical external additive is used, due to the sticking of the confetti-shaped particles even in the development step in which the pressure is not applied, dense dots are difficult to form. Further, in a case of the confetti-shaped particles formed of resin particles and a metal oxide as described in Japanese Patent No. 5982003, the confetti-shaped particles are embedded in the surface of the toner particles due to long-term use, and thus the dot reproducibility is further degraded due to a change in the state of the particles.

### SUMMARY

The present disclosure provides a toner that addresses the above-described disadvantages, and specifically, the present disclosure provides a toner that exhibits satisfactory dot reproducibility even on media with a highly uneven surface, such as rough paper, from the initial stage to the stage after endurance.

According to the present disclosure, there is provided a toner including: a toner particle; a composite particle present on a surface of the toner particle; and a spherical silica fine particle, in which the composite particle includes a fine particle A containing, as a binder component, an organic silicon compound that has a siloxane bond, and a fine particle B which is an inorganic fine particle, the fine particle B is present on a surface of the composite particle in a state where a part of the fine particle B is embedded in a surface of the fine particle A, Da is a number average particle diameter of the composite particle, Db is a number average particle diameter of the spherical silica fine particle, Db is 0.03 μm or greater and 0.30 μm or less, and 0.4≤Da/Db≤1.8 is satisfied, Pa is a proportion of a silicon atom represented by Si^{a} in a structure represented by a unit (a), Pb is a proportion of a silicon atom represented by Si^{b} in a structure represented by a unit (b), Pc is a proportion of a silicon atom represented by Si^{c} in a structure represented by a unit (c) based on all silicon atoms contained in the organic silicon compound of the fine particle A, and Pa, Pb, and Pc satisfy Expressions (1) to (3),

$$Pa + Pb + Pc \geq 0 \text{.80} \qquad ( 1 )$$

$$Pb + Pc \geq 0 \text{.30} \qquad ( 2 )$$

$$Pa \leq 0.7 \qquad ( 3 )$$

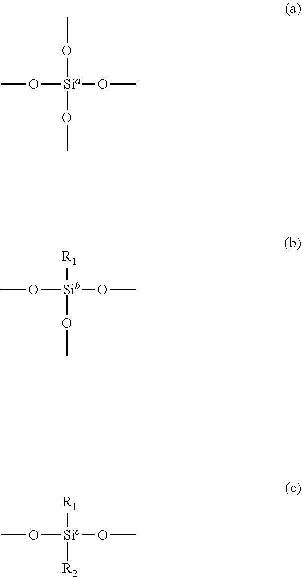

R₁ and R₂ represent an alkyl group having 1 or more and 6 or less carbon atoms, and
an average value of embedding ratios of the fine particle B represented by the following equation to the fine particle A in the composite particle is 30% or greater and 90% or less.

$$Emb edding ratio ( \% ) of fine particle B to fine particle A = ( depth of fine particle B embedded in fine particle A / diameter of fine particle B ) \times 100$$

Further features of the present disclosure will become apparent from the following description of exemplary embodiments.

### DESCRIPTION OF THE EMBODIMENTS

In the present disclosure, the description of a numerical range of “OO or greater and XX or less” or “OO to XX” denotes a numerical range including the endpoints as the lower limit and the upper limit unless otherwise specified.

### Features of Present Disclosure

The present inventors have considered the mechanism by which the effects of the present disclosure are exhibited as follows.

In a case where spherical silica fine particles and confetti-shaped composite particles containing an organic silicon compound as a binder component are used together as an external additive for a toner, since the binder portion of the composite particles has elasticity, the binder portion of the composite particles is deformed when a pressure is applied thereto, a plurality of protrusions of the composite particles bite into the toner, and as a result, the adhesion force between toner particles is increased. Meanwhile, in a state where a pressure is not applied to the composite particles, spherical silica is capable of suppressing an increase in adhesion force between toner particles due to protrusions of the composite particles interlocking each other as in a case where only the composite particles are externally added, and thus the flowability is enhanced.

That is, dense dots can be formed because the flowability is high in the development step in which the pressures is not applied, and the formed dots can be transferred without collapse because the adhesion force between toner particles increases in the transferring step in which the pressure is applied. Further, since the composite particles contain an organic silicon compound as a binder component, the composite particles have moderate elasticity and are unlikely to be embedded in the toner even by endurance, and therefore, the above-described effects are considered to be maintained even after endurance.

The present disclosure relates to a toner including a toner particle, a composite particle present on a surface of the toner particle as an external additive, and a spherical silica fine particle (hereinafter, also referred to as “silica fine particle”), and the external additive has the following features.
(i) The composite particle includes a fine particles A containing, as a binder component, an organic silicon compound that has a siloxane bond, and a fine particle B which is an inorganic fine particle, and the fine particle B is present on a surface of the composite particle in a state where a part of the fine particle B is embedded in a surface of the fine particle A.
(ii) Da is a number average particle diameter of the composite particle, Db is a number average particle diameter of the spherical silica fine particle, Db is 0.03 μm or greater and 0.30 μm or less, and 0.4≤Da/Db≤1.8 is satisfied.
(iii) Pa is a proportion of a silicon atom represented by Si^{a} in a structure represented by a unit (a), Pb is a proportion of a silicon atom represented by Si^{b} in a structure represented by a unit (b), Pc is a proportion of a silicon atom represented by Si^{c} in a structure represented by a unit (c) based on all silicon atoms contained in the organic silicon compound of the fine particle A, and Pa, Pb, and Pc satisfy Expressions (1) to (3).

$$Pa + Pb + Pc \geq 0 \text{.80} \qquad ( 1 )$$

$$Pb + Pc \geq 0.30 \qquad ( 2 )$$

$$Pa \leq 0.7 \qquad ( 3 )$$

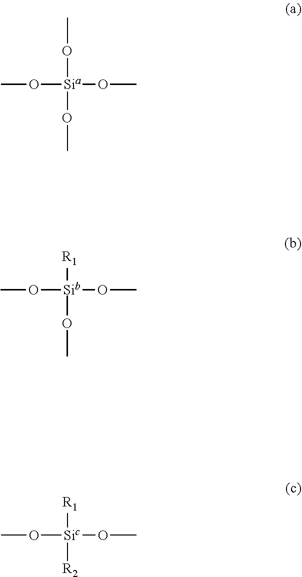

R₁ and R₂ represent an alkyl group having 1 or more and 6 or less carbon atoms. (iv) An average value of embedding ratios of the fine particle B represented by the following equation to the fine particle A in the composite particle is 30% or greater and 90% or less.

$$Emb edding ratio ( \% ) of fine particle B to fine particle A = ( depth of fine particle B embedded in fine particle A / diameter of fine particle B ) \times 100$$

External additive (composite particles and silica fine particles)

Hereinafter, the configuration of the external additive according to the present disclosure will be described in detail.

The number average particle diameter of the silica fine particles present on the surface of the toner particles according to the present disclosure is 0.03 μm or greater and 0.30 μm or less. In a case where the number average particle diameter thereof is in the above-described range, the toner particles can be uniformly coated with the silica fine particles. In a case where the number average particle diameter of the silica fine particles is less than 0.03 μm, since the stress on the toner increases when a large amount of images with a low printing density are output over a long period of time, the silica fine particles are embedded in the surface of the toner, the adhesion force between the toner particles is increased, dense dots cannot be formed in the development step, and as a result, the dot reproducibility is deteriorated. Further, in a case where the number average particle diameter thereof is greater than 0.30 μm, the silica fine particles are desorbed from the surface of the toner, the adhesion force is increased, and as a result, the dot reproducibility is deteriorated.

The number average particle diameter of the silica fine particles is preferably 0.07 μm or greater and 0.20 μm or less and more preferably 0.08 μm or greater and 0.15 μm or less from the above-described viewpoints.

Da is the number average particle diameter of the composite particles present on the surface of the toner particles of the toner according to the present disclosure, Db is the number average particle diameter of the silica fine particles, and 0.4≤Da/Db≤1.8 is satisfied. When Da/Db is in the above-described range, since the adhesion force between the toner particles decreases in a state where the pressure is not applied and the adhesion force between the toner particles increases in a state where the pressure is applied, the dot reproducibility is enhanced. In a case where Da/Db is less than 0.4, since the composite particles are extremely large relative to the silica fine particles, the protrusions of the composite particles interlock each other even in a state where the pressure is not applied, the adhesion force between the toner particles is increased, dense dots cannot be formed in the development step, and thus the dot reproducibility is deteriorated. Further, in a case where Da/Db is greater than 1.8, since the silica particles are extremely large relative to the composite particles, the effect of the protrusions of the composite particles biting into the toner is unlikely to be obtained even when the pressure is applied, the effect of an increase in adhesion force between the toner particles when the pressure is applied is weak, and as a result, dot collapse is likely to occur in the transferring step.

Da/Db is preferably 0.5 or greater and 1.5 or less and more preferably 0.7 or greater and 1.3 or less from the above-described viewpoint.

Pa is the proportion of a silicon atom represented by Si^{a} in a structure represented by the following unit (a), Pb is the proportion of a silicon atom represented by Si^{b} in a structure represented by the following unit (b), Pc is the proportion of a silicon atom represented by Si^{c} in a structure represented by the following unit (c) based on all silicon atoms contained in an organic silicon compound of fine particles A containing the organic silicon compound as a binder component in the composite particles, and Pa, Pb, and Pc satisfy Expressions (1) to (3).

$$Pa + Pb + Pc \geq 0 \text{.80} \qquad ( 1 )$$

$$Pb + Pc \geq 0.3 \qquad ( 2 )$$

$$Pa / ( Pa + Pb + Pc ) \leq 0.7 \qquad ( 3 )$$

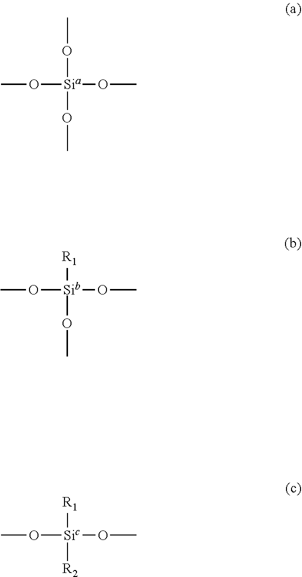

R₁ and R₂ represent an alkyl group having 1 or more and 6 or less carbon atoms.

In a case where the values are in the above-described ranges, the fine particles A have moderate elasticity, and thus the initial adhesiveness can be maintained without the fine particles A being embedded in the toner even in a case where the stress is applied to the toner from a member such as a carrier due to long-term use. Further, since the fine particles A are unlikely to be destroyed, the organic silicon compound functions as a binder component for fine particles B, and the initial embedded state of the fine particles B can also be maintained.

Pa, Pb, and Pc can be controlled by adjusting the amount of a silane monomer having each unit structure to be added. Pa, Pb, and Pc each may satisfy Expressions (I), (II), and (III).

$$0.3 \leq Pa / ( Pa + Pb + Pc ) \leq 0.7 \qquad ( I )$$

$$0 \leq Pb / ( Pa + Pb + P c ) \leq 0 \text{.50} \qquad ( II )$$

$$0.2 \leq Pc / ( Pa + Pb + P c ) \leq 0 \text{.70} \qquad ( III )$$

In the toner according to the present disclosure, the average value of the embedding ratios of the fine particles B represented by the following equation is 30% or greater and 90% or less.

$$Emb edding ratio ( \% ) of fine particle B = ( depth of fine particle B embedded in fine particle A / diameter of fine particle B ) \times 100$$

In a case where the average value of the embedding ratios is in the above-described range, since the fine particles B are unlikely to be desorbed from the fine particles A even in a case where the stress is applied to the toner from a member due to long-term use, the initial embedded state can be maintained. In a case where the average value of the embedding ratios is less than 30%, since the fine particle B are likely to be desorbed from the fine particles A, the effect of an increase in adhesion force between toner particles when the pressure is applied is weak. In a case where the average value of the embedding ratios is greater than 90%, since the effect of the protrusions biting into the toner when the pressure is applied is unlikely to be obtained, the effect of an increase in adhesion force between toner particles when the pressure is applied is weak, and thus the dot collapse is likely to occur in the transferring step.

The embedding ratio of the fine particles B can be controlled by adjusting the reaction time and the reaction temperature between the monomer and the fine particles B. In a case where the embedding ratio is intended to be decreased, a method of shortening the reaction time between the monomer and the fine particles B or lowering the reaction temperature may be employed. In a case where the embedding ratio is intended to be increased, a method of increasing the reaction time between the monomer and the fine particles B or increasing the reaction temperature may be employed. The embedding ratio thereof is preferably 40% or greater and 80% or less and more preferably 45% or greater and 70% or less.

When Dc is the average height of the portions of the fine particles B protruding from the fine particles A, Dc/Db is preferably 0.03 or greater and 0.30 or less. In a case where the average height thereof is in the above-described range, the composite particles sufficiently have a protrusion shape with respect to the silica fine particles, and thus the effect of the protrusions biting into the toner when the pressure is applied can be obtained. Dc/Db is more preferably 0.05 or greater and 0.20 or less from the above-described viewpoint.

In a case where A_{D} is the number average particle diameter of the primary particles of the fine particles A, and B_{D} is the number average particle diameter of the primary particles of the fine particles B, B_{D}/A_{D} is preferably 0.05 or greater and 0.70 or less. In a case where B_{D}/A_{D} is in the above-described range, the effect in which the flowability is not decreased when the pressure is not applied to the composite particles and the protrusions bite into the toner when the pressure is applied thereto can be obtained. B_{D}/A_{D} is more preferably 0.10 or greater and 0.50 or less from the above-described viewpoint.

The Young's modulus of the fine particles B is preferably 50 GPa or greater. In a case where the Young's modulus thereof is in the above-described range, the effect of the protrusions biting into the toner when the pressure is applied can be obtained. The Young's modulus of the fine particles B is more preferably 60 GPa or greater from the above-described viewpoint.

The content of the composite particles and the content of the silica fine particles with respect to 100 parts by mass of the toner particles are respectively preferably 0.10 parts by mass or greater and 20.0 parts by mass or less, more preferably 0.5 parts by mass or greater and 15.0 parts by mass or less, and still more preferably 1.0 parts by mass or greater and 10.0 parts by mass or less. In a case where the content of the composite particles and the content of the silica fine particles are less than 0.1 parts by mass, the flowability of the toner is extremely low, and therefore, dense dots are unlikely to be formed in the development step. Further, in a case where the content of the composite particles and the content of the silica fine particles are greater than 20.0 parts by mass, filming of external additive particles on a carrier, a charging member, and a photosensitive member may occur when images are output for a long period of time.

Further, the ratio (content of composite particles with respect to 100 parts by mass of toner particles)/(content of silica fine particles with respect to 100 parts by mass of toner particles) is preferably 0.2 or greater and 5.0 or less. In a case where the ratio thereof is in the above-described range, the effect in which the adhesion force between toner particles when the pressure is not applied decreases and the adhesion force between toner particles when the pressure is applied increases can be obtained. The ratio (content of composite particles/content of silica fine particles) described above is more preferably 0.5 or greater and 2.0 or less from the above-described viewpoint.

The fine particles B can be silica. In a case where the fine particles are silica, the fine particles B have moderate hardness, and thus the effect of the protrusions of the composite particles biting into the toner when the pressure is applied can be obtained. Further, in the case where the fine particles B are silica, the chargeability of silica fine particles to be added separately from the composite particles is similar to that of the fine particles B, and therefore, the charging distribution of the toner is likely to be uniform, and the developability and the transferability are enhanced.

The silica fine particles used in the present disclosure are particles containing silica (that is, SiO₂) as a main component and may be particles produced by using a silicon compound such as water glass or alkoxysilane as a raw material or particles obtained by pulverizing quartz.

Specific examples thereof include silica particles prepared by a sol-gel method, precipitated silica particles prepared by a precipitation method, aqueous colloidal silica particles, fumed silica particles obtained by a gas phase method, and fused silica particles. Among these, from the viewpoints of the reactivity with the above-described binder component and the dispersion stability, aqueous colloidal silica particles are preferable. The aqueous colloidal silica particles are commercially available or can be prepared from various starting materials by a known method. The aqueous colloidal silica particles can be prepared from silicic acid derived from an alkali silicate solution having a pH of about 9 to 11, and silicate anions undergo polymerization to generate silica particles having a desired average particle diameter in the form of an aqueous dispersion liquid.

The true specific gravity of the composite particles is preferably 1.00 g/cm³ or greater and 1.60 g/cm³ or less. In a case where the true specific gravity thereof is in the above-described range, since the amount of the fine particles B with respect to the fine particles A is appropriate, the effect of an increase in adhesion force between toner particles when the pressure is applied can be obtained, and the composite particles are unlikely to be embedded in the toner due to the moderate elasticity even in a case of long-term use. The true specific gravity thereof is more preferably 1.20 g/cm³ or greater and 1.50 g/cm³ or less from the above-described viewpoint.

The surface of the composite particles and the silica fine particles can be subjected to a surface treatment using a hydrophobic treatment agent. The hydrophobic treatment agent is not particularly limited, but an organic silicon compound is preferable. Examples thereof include an alkylsilazane compound such as hexamethyldisilazane, an alkylalkoxysilane compound such as diethyldiethoxysilane, trimethylmethoxysilane, methyltrimethoxysilane, or butyltrimethoxysilane, a fluoroalkylsilane compound such as trifluoropropyltrimethoxysilane, a chlorosilane compound such as dimethyldichlorosilane or trimethylchlorosilane, a siloxane compound such as octamethylcyclotetrasiloxane, silicone oil, and silicone varnish.

Further, the composite particles and the silica fine particles can be subjected to a surface treatment using the same hydrophobic treatment agent. In a case where the composite particles and the silica fine particles are subjected to a surface treatment using the same hydrophobic treatment agent, since the adhesion force between toner particles when the pressure is not applied decreases, dense dots can be formed in the development step. Among the above-described examples, the composite particles and the silica fine particles can be subjected to a surface treatment with at least one compound selected from the group consisting of an alkylsilazane compound, an alkylalkoxysilane compound, a chlorosilane compound, a siloxane compound, and silicone oil. Further, the composite particles and the silica fine particles can be subjected to a surface treatment with an alkylsilazane compound from the above-described viewpoint.

The Young's modulus of the composite particles is preferably 10 GPa or greater and 30 GPa or less. In a case where the Young's modulus of the composite particles is in the above-described range, since the composite particles have moderate elasticity, the composite particles are unlikely to be embedded in the toner even in a case of long-term use, and thus the initial adhesion force can be maintained.

### Method of Producing Composite Particles

The method of producing the composite particles according to the present disclosure is not particularly limited, but the composite particles can be formed by performing hydrolysis and a polycondensation reaction on a silicon compound (silane monomer) using a sol-gel method. Specifically, the composite particles can be formed by hydrolyzing and polycondensing a mixture of bifunctional silane having two siloxane bonds, trifunctional silane having three siloxane bonds, and tetrafunctional silane having four siloxane bonds and reacting the mixture with low-resistance fine particles (corresponding to the fine particles B). The silane monomers such as the bifunctional silane, the trifunctional silane, and the tetrafunctional silane will be described below. The proportion of the bifunctional silane is preferably 30% by mole or greater and 70% by mole or less, the proportion of the trifunctional silane is preferably 50% by mole or less, and the proportion of the tetrafunctional silane is preferably 30% by mole or greater and 80% by mole or less.

The composite particles according to the present disclosure mainly include the fine particles A that contain, as a binder, a silicon compound having a siloxane bond.

A method of producing the silicon compound is not particularly limited, and for example, the silicon compound can be obtained by adding a silane compound dropwise to water to carry out hydrolysis and the condensation reaction using a catalyst, and filtering and drying the obtained suspension. The particle diameter can be controlled by adjusting the kind of the catalyst, the blending ratio thereof, the reaction start time, the dropping time, and the like. Examples of the catalyst include an acidic catalyst such as hydrochloric acid, hydrofluoric acid, sulfuric acid, or nitric acid, and a basic catalyst such as ammonia water, sodium hydroxide, or potassium hydroxide, but the present disclosure is not limited thereto.

The silicon compound can be produced by the following method. Specifically, the method may include a first step of obtaining a hydrolyzate of a silicon compound, a second step of mixing the hydrolyzate, an alkaline aqueous medium, and a dispersion liquid of low-resistance particles to cause a polycondensation reaction of the hydrolyzate so that the hydrolyzate reacts with the low-resistance particles, and a third step of mixing the polycondensation reactant with an aqueous solution to form particles. In some cases, a hydrophobizing agent may be further blended into the mixture.

In the first step, a silicon compound and a catalyst are brought into contact with each other by, for example, a method of stirring or mixing the silicon compound and the catalyst in an aqueous solution obtained by dissolving an acidic or alkaline substance serving as a catalyst in water. A known catalyst can be suitably used as the catalyst. Specific examples of the catalyst include an acidic catalyst such as acetic acid, hydrochloric acid, hydrofluoric acid, sulfuric acid, or nitric acid, and a basic catalyst such as ammonia water, sodium hydroxide, or potassium hydroxide.

The amount of the catalyst to be used may be appropriately adjusted according to the kinds of the silicon compound and the catalyst. The amount thereof can be adjusted to be in a range of 1×10⁻³ parts by mass or greater and 1 part by mass or less with respect to 100 parts by mass of the amount of water used in a case of hydrolyzing the silicon compound.

In a case where the amount of the catalyst to be used is 1×10⁻³ parts by mass or greater, the reaction sufficiently proceeds. Meanwhile, in a case where the amount of the catalyst to be used is 1 part by mass or less, the concentration of the catalyst remaining as impurities in the fine particles is decreased, and thus the hydrolysis is easily carried out. The amount of water to be used is preferably 2 moles or greater and 15 moles or less with respect to 1 mole of the silicon compound. The hydrolysis reaction sufficiently proceeds in a case where the amount of water is 2 moles or greater, and the productivity is improved in a case where the amount of water is 15 moles or less.

The reaction temperature is not particularly limited, and the reaction may be carried out at room temperature or in a heated state, but the reaction can be carried out in a state where the temperature is maintained at 10° C. to 60° C. from the viewpoint of obtaining a hydrolyzate in a short time and suppressing a partial condensation reaction of the generated hydrolyzate. The reaction time is not particularly limited, and may be appropriately selected in consideration of the reactivity of the silicon compound to be used, the composition of a reaction solution obtained by compounding the silicon compound, an acid, and water, and the productivity.

In a method of producing silicon polymer particles, the raw material solution obtained in the first step described above is mixed with an alkaline aqueous medium to cause a polycondensation reaction of a particle precursor in a second step. In this manner, a polycondensation reaction solution is obtained. Here, the alkaline aqueous medium is a liquid obtained by mixing an alkaline component, water, and as necessary, an organic solvent.

The alkaline component used in the alkaline aqueous medium is a component in which the aqueous solution thereof exhibits basicity and which functions as a neutralizing agent of the catalyst used in the first step and also functions as the catalyst of the polycondensation reaction in the second step. Examples of such an alkaline component include an alkali metal hydroxide such as lithium hydroxide, sodium hydroxide, or potassium hydroxide, ammonia, and organic amines such as monomethylamine and dimethylamine.

The amount of the alkaline component to be used is an amount thereof used to neutralize an acid and effectively function as a catalyst of the polycondensation reaction, and for example, in a case where ammonia is used as the alkaline component, the amount thereof is selected to be in a range of typically 0.01 parts by mass or greater and 12.5 parts by mass or less with respect to 100 parts by mass of a mixture of water and an organic solvent.

In the second step, an organic solvent may be further used in addition to the alkaline component and water in order to prepare the alkaline aqueous medium. The organic solvent is not particularly limited as long as the organic solvent is compatible with water, but an organic solvent that dissolves 10 g or greater of water per 100 g of the organic solvent at room temperature under normal pressure is suitable.

Specific examples of the organic solvent include alcohol such as methanol, ethanol, n-propanol, 2-propanol, or butanol, polyhydric alcohol such as ethylene glycol, diethylene glycol, propylene glycol, glycerin, trimethylolpropane, or hexanetriol, ether such as ethylene glycol monoethyl ether, acetone, diethyl ether, tetrahydrofuran, or diacetone alcohol, and an amide compound such as dimethylformamide, dimethylactamide, or N-methylpyrrolidone.

Among the organic solvents described above, an alcohol-based solvent such as methanol, ethanol, 2-propanol, or butanol is preferable. Further, from the viewpoints of the hydrolysis and the dehydration condensation reaction, it is more preferable to select the same alcohol as the alcohol generated by desorption as the organic solvent.

In a third step, the polycondensation reactant obtained in the second step is mixed with an aqueous solution to form particles. Water (tap water, pure water, or the like) can be suitably used as the aqueous solution, and a component that is compatible with water, such as a salt, an acid, an alkali, an organic solvent, a surfactant, or a water-soluble polymer, may be further added to water. The temperature of the polycondensation reaction solution and the aqueous solution when mixed is not particularly limited, and is suitably selected to be in a range of 5° C. to 70° C. in consideration of the compositions thereof, the productivity, and the like.

A known method can be used without particular limitation as a method of recovering particles. Examples of such a method include a method of scooping floating powder and a filtration method. Among these, a filtration method is preferable from the viewpoint of a simple operation. The filtration method is not particularly limited, and vacuum filtration, centrifugal filtration, pressure filtration, or the like may be performed by selecting a known device. The filter paper, the filter, the filter cloth, and the like used in the filtration are not particularly limited as long as these are industrially available, and may be appropriately selected depending on the device to be used.

The monomer to be used can be appropriately selected depending on the compatibility with the solvent and the catalyst, the hydrolyzability, and the like. Examples of the tetrafunctional silane monomer having the structure represented by the unit (a) include tetramethoxysilane, tetraethoxysilane, and tetraisocyanatosilane. Among these, tetraethoxysilane is preferable.

Examples of the trifunctional silane monomer having the structure represented by the unit (b) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane. Among these, methyltrimethoxysilane is preferable.

Examples of the bifunctional silane monomer having the structure represented by the unit (c) include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and diethyldimethoxysilane. Among these, dimethyldimethoxysilane is preferable.

### Silica Fine Particles and Production Method Thereof

Examples of the silica fine particles include particles formed of silicon dioxide, such as wet silica obtained by a sedimentation method, a sol-gel method, or the like and dry silica obtained by a deflagration method, a fumed method, or the like, but dry silica is more preferable from the viewpoint of easily controlling the shape. Further, the concept of the silica fine particles according to the present disclosure includes particles obtained by performing a hydrophobic treatment on the silica with a hydrophobic treatment agent. The dry silica is formed of a silicon halogen compound or the like as a raw material. As the silicon halogen compound, silicon tetrachloride is used, but silanes such as methyl trichlorosilane and trichlorosilane can be used alone or silicon tetrachloride and silanes can be used in a mixed state as a raw material. After vaporization of the raw material, target silica is obtained by a so-called flame hydrolysis reaction of reacting the raw material with water generated as an intermediate in an oxyhydrogen flame. For example, a thermal decomposition oxidation reaction of silicon tetrachloride gas in oxygen and hydrogen is used, and the reaction formula is as follows.

SiCl₄+2H₂+O₂→SiO₂+4HCl

Hereinafter, a method of producing dry silica will be described.

Oxygen gas is supplied to a burner to ignite the ignition burner, hydrogen gas is supplied to the burner to form a flame, and silicon tetrachloride which is a raw material is added thereto for gasification. Next, a flame hydrolysis reaction is carried out, and generated silica powder is recovered. The average particle diameter and the shape can be arbitrarily adjusted by appropriately changing a silica tetrachloride flow rate, an oxygen gas supply flow rate, a hydrogen gas supply flow rate, and a retention time of silica in a flame. The silica fine particles can be subjected to a hydrophobic treatment. A silane compound, silicone oil, or a mixture thereof can be used as the hydrophobic treatment agent, but the hydrophobic treatment can be performed only with a silane compound from the viewpoint of obtaining excellent dispersibility of the inorganic fine particles.

### Constituent Material of Toner Particles

Next, the constituent materials of the toner particles according to the present disclosure will be described in detail.

### Binder Resin

The binder resin used in the toner according to the present disclosure is not particularly limited, and the following polymer or resin can be used as the binder resin.

Examples of the binder resin include homopolymers of styrene and substituents thereof, such as poly-p-chlorostyrene and polyvinyltoluene; styrene-based copolymers such as a styrene-p-chlorostyrene copolymer, a styrene-vinyltoluene copolymer, a styrene-vinylnaphthalene copolymer, a styrene-acrylic acid ester copolymer, a styrene-methacrylic acid ester copolymer, a styrene-α-methyl chloromethacrylate copolymer, a styrene-acrylonitrile copolymer, a styrene-vinyl methyl ether copolymer, a styrene-vinyl ethyl ether copolymer, a styrene-vinyl methyl ketone copolymer, and a styrene-acrylonitrile-indene copolymer; polyvinyl chloride, a phenol resin, a naturally modified phenol resin, a natural resin-modified maleic acid resin, an acrylic resin, a methacrylic resin, polyvinyl acetate, a silicone resin, a polyester resin, polyurethane, a polyamide resin, a furan resin, an epoxy resin, a xylene resin, polyvinyl butyral, a terpene resin, a coumarone-indene resin, and a petroleum-based resin. Among these, from the viewpoints of durable stability and charging stability, a polyester resin is preferable.

Further, the acid value of the polyester resin is preferably 0.5 mgKOH/g or greater and 40 mgKOH/g or less from the viewpoints of environmental stability and the charging stability. The acid value in the polyester resin and Si—CH₃ in the fine particles interact with each other, and as a result, the durability and the toner chargeability in a high-temperature high-humidity environment can be further improved. The acid value thereof is more preferably 1 mgKOH/g or greater and 20 mgKOH/g or less and still more preferably 1 mgKOH/g or greater and 15 mgKOH/g or less.

### Colorant

The toner according to the present disclosure may use a colorant as necessary. Examples of the colorant will be described below.

Examples of a black colorant include carbon black; and a colorant toned to black using a yellow colorant, a magenta colorant, and a cyan colorant. A pigment may be used alone in the colorant, but a colorant obtained by combining a dye and a pigment with improved sharpness is more preferable from the viewpoint of the image quality of a full-color image.

Examples of a pigment for a magenta toner include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; C.I. Violet 1, 2, 10, 13, 15, 23, 29, and 35.

Examples of a dye for a magenta toner include C.I. Solvent Red 1, 3, 8, 23, 24, 25, 27, 30, 49, 81, 82, 83, 84, 100, 109, and 121; C.I. disperse Red 9; C.I. Solvent Violet 8, 13, 14, 21, and 27; an oil-soluble dye such as C.I. Disperse Violet 1, C.I. Basic Red 1, 2, 9, 12, 13, 14, 15, 17, 18, 22, 23, 24, 27, 29, 32, 34, 35, 36, 37, 38, 39, and 40; and a basic dye such as C.I. Basic Violet 1, 3, 7, 10, 14, 15, 21, 25, 26, 27, and 28.

Examples of a pigment for a cyan toner include C.I. Pigment Blue 2, 3, 15:2, 15:3, 15:4, 16, and 17; C.I. Vat Blue 6; C.I. Acid Blue 45, and a copper phthalocyanine pigment in which 1 to 5 phthalimidomethyl groups are substituted with a phthalocyanine skeleton.

Examples of a dye for a cyan toner include C.I. Solvent Blue 70.

Examples of a pigment for a yellow toner include C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

Examples of a dye for a yellow toner include C.I. Solvent Yellow 162.

The content of the colorant is preferably 0.1 parts by mass or greater and 30.0 parts by mass or less with respect to 100 parts by mass of the binder resin.

### Wax

The toner according to the present disclosure may use wax as necessary. Examples of the wax include hydrocarbon-based wax such as microcrystalline wax, paraffin wax, or Fischer Tropsch; an oxide of hydrocarbon-based wax such as oxidized polyethylene wax or a block copolymer thereof; waxes containing fatty acid ester as a main component, such as carnauba wax; and waxes obtained by partially or entirely deoxidizing fatty acid esters, such as deoxidized carnauba wax.

Other examples of the wax include straight-chain saturated fatty acids such as palmitic acid, stearic acid, and montanoic acid; unsaturated fatty acids such as brassidic acid, eleostearic acid, and parinaric acid; saturated alcohols such as stearyl alcohol, aralkyl alcohol, behenyl alcohol, carnaubyl alcohol, ceryl alcohol, and melissyl alcohol; polyhydric alcohols such as sorbitol; esters of fatty acids such as palmitic acid, stearic acid, behenic acid, and montanoic acid with alcohols such as stearyl alcohol, aralkyl alcohol, behenyl alcohol, carnaubyl alcohol, ceryl alcohol, and melissyl alcohol; fatty acid amides such as linoleic acid amide, oleic acid amide, and lauric acid amide; saturated fatty acid bisamides such as methylene bisstearic acid amide, ethylene biscapric acid amide, ethylene bislauric acid amide, and hexamethylene bisstearic acid amide; unsaturated fatty acid amides such as ethylene bisoleic acid amide, hexamethylene bisoleic acid amide, N,N′-dioleyl adipic acid amide, and N,N′-dioleyl sebacic acid amide, aromatic bisamides such as m-xylene bisstearic acid amide and N,N′-distearyl isophthalic acid amide; aliphatic metal salts (commonly known as metallic soap) such as calcium stearate, calcium laurate, zinc stearate, and magnesium stearate; waxes grafted to aliphatic hydrocarbon-based wax using a vinyl-based monomer such as styrene or acrylic acid; a partially esterified substance of polyhydric alcohol and fatty acids such as behenic acid monoglyceride; and a methyl ester compound containing a hydroxyl group obtained by hydrogenating vegetable fats and oils.

The content of the wax is preferably 2.0 parts by mass or greater and 30.0 parts by mass or less with respect to 100 parts by mass of the binder resin.

### Charge Control Agent

The toner according to the present disclosure can also contain a charge control agent as necessary. A known charge control agent can be used as the charge control agent contained in the toner, but a metal compound of an aromatic carboxylic acid which is colorless, has a high charging speed, and stably maintains a constant charge amount is particularly preferable.

Examples of a negative charge control agent include a salicylic acid metal compound, a naphthoic acid metal compound, a dicarboxylic acid metal compound, a polymer type compound having sulfonic acid or a carboxylic acid in a side chain, a polymer type compound having a sulfonate or a sulfonic acid esterified substance in a side chain, a polymer type compound having a carboxylate or a carboxylic acid esterified substance in a side chain, a boron compound, a urea compound, a silicon compound, and a calixarene. The charge control agent may be added internally or externally to the toner particles.

The amount of the charge control agent to be added is preferably 0.2 parts by mass or greater and 10.0 parts by mass or less with respect to 100 parts by mass of the binder resin.

### Inorganic Fine Powder

A combination of other inorganic fine powders can also be used as necessary in the toner according to the present disclosure in addition to the above-described fine particles. The inorganic fine powder may be internally added to the toner particles or may be mixed with the toner base particles as the external additive. Inorganic fine powder is preferable as the external additive. The inorganic fine powder can be hydrophobized with a hydrophobizing agent such as a silane compound, silicone oil, or a mixture thereof.

Inorganic fine powder having a specific surface area of 50 m²/g or greater and 400 m²/g or less is preferable as the external additive for improving the flowability. Inorganic fine powders having the specific surface areas in the above-described range may also be used in combination in order to achieve both improvement of the flowability and stabilization of the durability. The content of the inorganic fine powder is preferably 0.1 parts by mass or greater and 10.0 parts by mass or less with respect to 100 parts by mass of the toner particles. In a case where the content thereof is in the above-described range, the effect of durable stability is likely to be obtained.

### Developer

The toner according to the present disclosure can be used as a one-component developer, but the toner can be mixed with a magnetic carrier and used as a two-component developer in order to further improve dot reproducibility from the viewpoint of obtaining an image stabilized over a long period of time. That is, the two-component developer may contain a toner and a magnetic carrier, and the toner may be the toner according to the present disclosure.

Examples of the magnetic carrier include commonly known magnetic carriers such as surface-oxidized iron powder, unoxidized iron powder, metal particles such as iron, lithium, calcium, magnesium, nickel, copper, zinc, cobalt, manganese, chromium, and rare earth elements, alloy particles thereof, oxide particles, a magnetic material such as ferrite, and a magnetic material-dispersed resin carrier (so-called resin carrier) containing a magnetic substance and a binder resin that maintains the magnetic material in a dispersed state.

In a case where the toner is mixed with the magnetic carrier and used as a two-component developer, usually satisfactory results can be obtained when the mixing ratio of the carrier is set to preferably 2% by mass or greater and 15% by mass or less and more preferably 4% by mass or greater and 13% by mass or less with respect to the concentration of the toner in the two-component developer.

### Method of Producing Toner Particles and Method of Producing Toner

A method of producing the toner particles is not particularly limited, and a known production method of the related art, such as a suspension polymerization method, an emulsion aggregation method, a melt kneading method, or a dissolution suspension method, can be employed.

The toner may be obtained by mixing the obtained toner particles with inorganic fine particles and, as necessary, other external additives. The toner particles can be mixed with the inorganic fine particles and other external additives by using a mixing device such as a double cone mixer, a V-type mixer, a drum type mixer, a super mixer, a Henschel mixer, a Nauta mixer, Mechano Hybrid (manufactured by NIPPON COKE & ENGINEERING CO., LTD.), or NOBILTA (manufactured by Hosokawa Micron Corporation).

### Method of Measuring Various Physical Properties

Methods of measuring various physical properties will be described below.

Separation of Fine Particles and Toner Particles from Toner

Each physical property can be measured by using the fine particles separated from the toner by the following method.

200 g of sucrose (manufactured by Kishida Chemical Co., Ltd.) is added to 100 mL of ion exchange water and dissolved in a hot water bath to prepare a concentrated sucrose solution. 31 g of the concentrated sucrose liquid and 6 mL of Contaminon N (10 mass % aqueous solution for a neutral detergent for cleaning a precision measuring instrument, which consists of a nonionic surfactant, an anionic surfactant, and an organic builder and has a pH of 7, manufactured by FUJIFILM Wako Pure Chemical Corporation) are placed in a centrifuge tube to prepare a dispersion liquid. 1 g of the toner is added to the dispersion liquid, and toner clumps are loosened with a spatula or the like.

The centrifuge tube is shaken in a shaker for 20 minutes under a condition of reciprocation performed 350 times per minute. After the shaking, the solution is transferred to a glass tube (50 mL) for a swing rotor and centrifuged by a centrifuge under conditions of 3500 rpm for 30 minutes. In the glass tube after the centrifugation, the toner is present on the uppermost layer, and the fine particles are present on the underlayer on the aqueous solution side. The aqueous solution on the underlayer is collected and centrifuged to separate the sucrose and the fine particles, and the fine particles are collected. The centrifugation is repeatedly performed as necessary to sufficiently carry out the separation, the dispersion liquid is dried, and the fine particles collected.

In a case where a plurality of external additives are added, the external additive according to the present disclosure can be sorted out by using a centrifugal separation method or the like.

### Method of Measuring Number Average Particle Diameter of Primary Particles of External Additive

The number average particle diameter of the primary particles of the external additive can be determined by performing measurement using a centrifugal sedimentation method. Specifically, 0.01 g of the dried external additive particles are put into a 25 mL glass vial, and a solution is prepared by adding 0.2 g of a 5% triton solution and 19.8 g of RO water to the particles. Next, a probe (tip inside the tip) of an ultrasonic disperser is immersed in the solution and subjected to ultrasonic dispersion at an output of 20 W for 15 minutes, thereby obtaining a dispersion liquid. Subsequently, the number average particle diameter of the primary particles is measured using this dispersion liquid by a centrifugal sedimentation particle size distribution measuring device DC24000 (manufactured by CPS Instruments, Inc.). The rotation speed of a disk is set to 18000 rpm, and the true density is set to 1.3 g/cm³. Before the measurement, the device is subjected to calibration using polyvinyl chloride particles having an average particle diameter of 0.476 μm.

### Method of Measuring Embedding Ratio of Fine Particles B

The external additive is sufficiently dispersed in a visible light-curable resin (trade name, ARONIX LCR Series D-800, manufactured by TOAGOSEI CO., LTD.), and the resin is irradiated with short-wavelength light and cured. The obtained cured substance is cut out using an ultramicrotome provided with a diamond knife to prepare a flaky sample with a size of 250 nm. Next, the cut-out sample is magnified at a magnification of 40000 times to 50000 times using a transmission electron microscope (electron microscope JEM-2800, manufactured by JEOL Ltd.) (TEM-EDX), and a cross section of the external additive is observed. The diameter of the fine particles B and the depth of the fine particles B embedded in the fine particles A are measured from the cross-sectional image. Five fine particles B per particle of the external additive are randomly selected, and the embedding ratio of the fine particles B is calculated according to the following equation. Further, the number of particles of the external additive to be analyzed is set to 20 particles or more, and the average value of the obtained embedding ratios is defined as the embedding ratio of the fine particles B.

$$Emb edding ratio ( \% ) of fine particle B = ( depth of fine particle B embedded in fine particle A / diameter of fine particle B ) \times 100$$

Method of Measuring B_{D}/A_{D} of External Additive

A cross section of the external additive is observed by the above-described method to calculate B_{D}/A_{D} of the external additive. The particle diameters of the fine particles A and the fine particles B are calculated from the image obtained by the observation. As the number of particles to be analyzed, the number of external additive particles is set to 20 particles, and the average value thereof is defined as the value of B_{D}/A_{D} in the present disclosure.

Method of measuring content proportion of constituent compound in external additive according to solid-state ²⁹Si-NMR

In the solid-state ²⁹Si-NMR, peaks are detected in different shift regions by the structure of the functional group bonded to Si of the constituent compound of the external additive. The structure bonded to Si can be specified by specifying each peak position using a standard sample. Further, the abundance ratio of each constituent compound can be calculated from the obtained peak area. The ratios of the peak areas of an M unit structure, a D unit structure (c), a T unit structure (b), and a Q unit structure (a) with respect to the entire peak area can be determined by calculation.

Specifically, the measurement conditions for solid-state ²⁹Si-NMR are as follows.
Device: JNM-ECX5002 (JEOL RESONANCE)
Temperature: room temperature
Measuring method: DDMAS method 29Si 45°
Sample tube: zirconia 3.2 mmϕ
Sample: sample tube filled with sample in powder state
Sample rotation speed: 10 kHz
Relaxation delay: 180 s
Scan: 2000

After the measurement, a plurality of silane components of the sample having different substituents and bonding groups are separated into peaks of the following M unit structure, D unit structure (c), T unit structure (b), and Q unit structure (a) by performing curve fitting, and each peak area is calculated.

The curve fitting is performed using EXcalibur for Windows (registered trademark) version 4.2 (EX series) for software for JNM-EX400 (manufactured by JEOL Ltd.). The measurement data is read by clicking “1D Pro” from the menu icons. Next, “Curve fitting function” is selected from “Command” of the menu bar, and curve fitting is performed. The curve fitting for each component is performed such that a difference (synthesized peak difference) between a synthesized peak formed by synthesizing each peak obtained by curve fitting and a peak which is the measurement result is minimized.
M unit structure: (Ra)(Rb)(Rc) SiO_{1/2}
D unit structure: (Rd)(Re)Si(O_{1/2})₂ (c)
T unit structure: RfSi(O_{1/2})₃ (b)
Q unit structure: Si(O_{1/2})₄ (a)

Ra, Rb, Rc, Rd, Re, and Rf in the formulae shown above represent an organic group (for example, an alkyl group or an alkoxy group) such as a hydrocarbon group having 1 or more and 6 or less carbon atoms, which is bonded to silicon, a halogen atom, or a hydroxy group. The content proportions of (a), (b), and (c) in the external additive are calculated from the peak area corresponding to the structure represented by Formula (a), the peak area corresponding to the structure represented by Formula (b), and the peak area corresponding to the structure represented by Formula (c), which are obtained by the measurement. Further, in a case where the structures are required to be confirmed in more detail, the measurement results of ¹³C-NMR and ¹H-NMR may be identified along with the measurement results of ²⁹Si-NMR.

### Method of Measuring True Specific Gravity of External Additive

The true specific gravity of the external additive is measured by a dry type automatic densitometer AUTOPYCNOMETER (manufactured by Yuasa Ionics Co., Ltd.). The conditions for the measurement are as follows.
Cell: SM cell (10 ml)
Sample amount: 0.05 g

This measurement method is a method of measuring the true specific gravity of a solid and a liquid using a gas phase substitution method.

Similarly to a liquid phase substitution method, this method is based on Archimedes' principle, but has high precision for micropores because gas (argon gas) is used as a substitution medium.

### Method of Measuring Surface Treatment Agent of External Additive

A surface treatment agent of the external additive is analyzed by pyrolysis GC-MS (gas chromatography mass spectrometry).

The specific measurement conditions are as follows.
Device: GC6890A (manufactured by Agilent Technologies), pyrolyzer (manufactured by Japan Analytical Industry Co., Ltd.)
Column: HP-5 ms 30 m
Pyrolysis temperature: 590° C.

The surface treatment agent of the external additive is specified by specifying each peak position of the profile obtained by the measurement using a standard sample.

### Method of Measuring Young's Modulus of Composite Particles

The Young's modulus of the composite particles is determined by a microcompression test performed using a Hysitron PI 85 L Picoindenter (manufactured by BRUKER). The Young's modulus (MPa) is calculated from the inclination of the profile (load-displacement curve) of the displacement (nm) and the test force (μN) obtained by the measurement.
Device and jig
Base system: Hysitron PI-85 L
Measurement indenter: circular flat end indenter with diameter of 1 μm
SEM used: Thermo Fisher Versa 3D
Conditions for SEM: −10° tilt, 13 pA at 10 keV
Measurement conditions
Measurement mode: displacement control
Maximum displacement: 30 nm
Displacement speed: 1 nm/sec
Retention time: 2 seconds
Unloading speed: 5 nm/sec
Analysis method

Hertz analysis is applied to a curve in a case of compressing the obtained load-displacement curve by 0 nm to 10 nm, and the Young's modulus of the composite particles is calculated.
Sample adjustment

A sample is prepared by attaching the composite particles onto a silicon wafer.

### Method of Measuring Young's Modulus of Fine Particles B

First, the composition of the fine particles B is identified. The measurement is performed using a scanning electron microscope “S-4800” (trade name, manufactured by Hitachi, Ltd.). An external additive in which a difference in contrast of an image occurs between a site derived from the fine particles B as an inorganic substance and a site derived from the fine particles A as an organic substance is defined as the external additive for the toner according to the present disclosure, and an external additive in which the difference in contrast has not occurred is defined as an external additive other than the external additive for the toner according to the present disclosure. Further, the fine particles B as an inorganic substance are observed to have a higher brightness. The external additives are observed, and the compositions of the fine particles A and the fine particles B are identified with an energy dispersive X-ray analyzer in a visual field magnified up to a maximum of 2000000 times. The composition of the fine particles B is identified, fine particles having the same composition as the composition of the fine particles B are prepared, the Young's modulus of the fine particles is measured in the same manner as the measurement of the Young's modulus of the composite particles described above, and the obtained value is defined as the Young's modulus of the fine particles B.

### EXAMPLES

Hereinafter, the present disclosure will be described in more detail with reference to examples. However, the present disclosure is not limited to thereto. In the following formulations, “parts” are on a mass basis unless otherwise specified. Production Example of composite particles 1

### 1. Hydrolysis and Polycondensation Step

(1) A 500 ml beaker was charged with 21.6 g of RO water, 135.0 g of methanol, 0.004 g of acetic acid as a catalyst, and 12.2 g of dimethyldimethoxysilane, and the mixture was stirred at 45° C. for 5 minutes.
(2) 2.0 g of 28% ammonia water, 15.0 g of tetraethoxysilane, and 5.0 g of a colloidal silica aqueous dispersion liquid A (silica solid content: 40% by mass, particle diameter of 30 nm) were added thereto, and the mixture was stirred at 30° C. for 3.0 hours, thereby obtaining a raw material solution.

### 2. Granulation Step

120.0 g of RO water was put into a 1000 ml beaker, and the raw material solution obtained in the step 1 was added dropwise thereto for 5 minutes while the mixture was stirred at 25° C. Thereafter, the mixed solution was heated to 60° C. and stirred for 1.5 hours while the temperature of the solution was maintained at 60° C., thereby obtaining a dispersion liquid of the composite particles.

### 3. Hydrophobization Step

6.0 g of hexamethyldisilazane was added, as a hydrophobizing agent, to the dispersion liquid of the composite particles obtained in 2. Granulation step described above, and the solution was stirred at 60° C. for 3.0 hours. The solution was allowed to stand for 5 minutes, and the powder precipitated in the lower portion of the solution was recovered by suction filtration and dried under reduced pressure at 120° C. for 24 hours, thereby obtaining composite particles 1. The physical properties of the obtained composite particles 1 are listed in Table 1.

### Production Example of Composite Particles 2

Composite particles 2 were obtained in the same manner as in the production example of the composite particles 1 except that the amount of dimethyldimethoxysilane was changed to 7.2 g in the item (1) of 1. Hydrolysis and polycondensation step described above and the amount of the tetraethoxysilane was changed to 20.0 g in the item (2) thereof. The physical properties of the obtained composite particles 2 are listed in Table 1.

### Production Example of Composite Particles 3

Composite particles 3 were obtained in the same manner as in the production example of the composite particles 1 except that the amount of dimethyldimethoxysilane was changed to 14.5 g in the item (1) of 1. Hydrolysis and polycondensation step described above and the amount of the tetraethoxysilane was changed to 12.7 g in the item (2) thereof. The physical properties of the obtained composite particles 3 are listed in Table 1.

### Production Example of Composite Particles 4

Composite particles 4 were obtained in the same manner as in the production example of the composite particles 1 except that the amount of dimethyldimethoxysilane was changed to 16.0 g in the item (1) of 1. Hydrolysis and polycondensation step described above and the amount of the tetraethoxysilane was changed to 11.2 g in the item (2) thereof. The physical properties of the obtained composite particles 4 are listed in Table 1.

### Production Example of Composite Particles 5

Composite particles 5 were obtained in the same manner as in the production example of the composite particles 1 except that the amount of dimethyldimethoxysilane was changed to 19.2 g in the item (1) of 1. Hydrolysis and polycondensation step described above and the amount of the tetraethoxysilane was changed to 8.0 g in the item (2) thereof. The physical properties of the obtained composite particles 5 are listed in Table 1.

### Production Example of Composite Particles 6

Composite particles 6 were obtained in the same manner as in the production example of the composite particles 1 except that the amount of dimethyldimethoxysilane was changed to 5.0 g in the item (1) of 1. Hydrolysis and polycondensation step described above, and the amount of the tetraethoxysilane was changed to 10.2 g and 12.0 g of trimethoxymethylsilane was added in the item (2) thereof. The physical properties of the obtained composite particles 6 are listed in Table 1.

### Production Example of Composite Particles 7

Composite particles 7 were obtained in the same manner as in the production example of the composite particles 1 except that 27.2 g of trimethoxymethylsilane was added in place of dimethyldimethoxysilane in the item (1) of 1. Hydrolysis and polycondensation step described above and tetraethoxysilane was not added in the item (2) thereof. The physical properties of the obtained composite particles 7 are listed in Table 1.

### Production Example of Composite Particles 8

Composite particles 8 were obtained in the same manner as in the production example of the composite particles 1 except that the hydrophobizing agent used was changed to octamethylcyclotetrasiloxane in the hydrophobization step. The physical properties of the obtained composite particles 8 are listed in Table 1.

### Production Example of Composite Particles 9

Composite particles 9 were obtained in the same manner as in the production example of the composite particles 1 except that hexamethyldisilazane was not added in the hydrophobization step. The physical properties of the obtained composite particles 9 are listed in Table 1.

### Production Example of Composite Particles 10

Composite particles 10 were obtained in the same manner as in the production example of the composite particles 1 except that the amount of the colloidal silica dispersion liquid A was changed to 8.0 g in the item (2) of 1. Hydrolysis and polycondensation step described above. The physical properties of the obtained composite particles 10 are listed in Table 1.

### Production Example of Composite Particles 11

Composite particles 11 were obtained in the same manner as in the production example of the composite particles 1 except that the amount of the colloidal silica dispersion liquid A was changed to 10.0 g in the item (2) of 1. Hydrolysis and polycondensation step described above. The physical properties of the obtained composite particles 11 are listed in Table 1.

### Production Example of Composite Particles 12

Composite particles 12 were obtained in the same manner as in the production example of the composite particles 1 except that 7.0 g of a titanium oxide aqueous dispersion liquid (titanium oxide solid content: 40% by mass, particle diameter of 28 nm) was used in place of 5.0 g of the colloidal silica aqueous dispersion liquid A in the item (2) of 1. Hydrolysis and polycondensation step described above. The physical properties of the obtained composite particles 12 are listed in Table 1.

### Production Example of Composite Particles 13

Composite particles 13 were obtained in the same manner as in the production example of the composite particles 1 except that a colloidal silica dispersion liquid B (silica solid content: 40% by mass, particle diameter of 5 nm) was used in place of the colloidal silica aqueous dispersion liquid A and the stirring temperature was changed to 28° C. in the item (2) of 1. Hydrolysis and polycondensation step described above.

The physical properties of the obtained composite particles 13 are listed in Table 1.

### Production Example of Composite Particles 14

Composite particles 14 were obtained in the same manner as in the production example of the composite particles 1 except that a colloidal silica dispersion liquid C (silica solid content: 40% by mass, particle diameter of 70 nm) was used in place of the colloidal silica aqueous dispersion liquid A in the item (2) of 1. Hydrolysis and polycondensation step described above. The physical properties of the obtained composite particles 14 are listed in Table 1.

### Production Example of Composite Particles 15

Composite particles 15 were obtained in the same manner as in the production example of the composite particles 13 except that a colloidal silica dispersion liquid D (silica solid content: 40% by mass, particle diameter of 3 nm) was used in place of the colloidal silica aqueous dispersion liquid B in the item (2) of 1. Hydrolysis and polycondensation step described above. The physical properties of the obtained composite particles 15 are listed in Table 1.

### Production Example of Composite Particles 16

Composite particles 16 were obtained in the same manner as in the production example of the composite particles 1 except that a colloidal silica dispersion liquid E (silica solid content: 40% by mass, particle diameter of 75 nm) was used in place of the colloidal silica aqueous dispersion liquid A in the item (2) of 1. Hydrolysis and polycondensation step described above. The physical properties of the obtained composite particles 16 are listed in Table 1.

### Production Example of Composite Particles 17

Composite particles 17 were obtained in the same manner as in the production example of the composite particles 16 except that the stirring temperature was changed to 28° C. in the item (2) of 1. Hydrolysis and polycondensation step described above. The physical properties of the obtained composite particles 17 are listed in Table 1.

### Production Example of Composite Particles 18

Composite particles 18 were obtained in the same manner as in the production example of the composite particles 1 except that the stirring temperature was changed to 35° C. in the item (2) of 1. Hydrolysis and polycondensation step described above. The physical properties of the obtained composite particles 18 are listed in Table 1.

### Production Example of Composite Particles 19

Composite particles 19 were obtained in the same manner as in the production example of the composite particles 1 except that 2.0 g of 28% ammonia water and 15.0 g of tetraethoxysilane were added, the mixture was stirred at 30° C. for 2.5 hours, 5.0 g of the colloidal silica aqueous dispersion liquid A was added thereto, and the mixture was further stirred for 0.5 hours to obtain a raw material solution in the item (2) of 1. Hydrolysis and polycondensation step described above. The physical properties of the obtained composite particles 19 are listed in Table 1.

### Production Example of Composite Particles 20

Composite particles 20 were obtained in the same manner as in the production example of the composite particles 1 except that the amount of dimethyldimethoxysilane was changed to 3.2 g in the item (1) of 1. Hydrolysis and polycondensation step described above and the amount of the tetraethoxysilane was changed to 24.0 g in the item (2) thereof. The physical properties of the obtained composite particles 20 are listed in Table 1.

### Production Example of Composite Particles 21

Composite particles 21 were obtained in the same manner as in the production example of the composite particles 1 except that the amount of 28% ammonia water was changed to 1.8 g in the item (2) of 1. Hydrolysis and polycondensation step described above. The physical properties of the obtained composite particles 21 are listed in Table 1.

### Production Example of Composite Particles 22

A 250 mL four-necked round bottom flask equipped with an overhead stirring motor, a condenser, and a thermocouple was charged with 18.7 g of a colloidal silica dispersion liquid (silica solid content: 40% by mass, particle diameter: 30 nm), 125 mL of DI water, and 16.5 g (0.066 moles) of methacryloxypropyl-trimethoxysilane. The temperature was increased to 65° C., and the mixture was stirred at 120 rpm. The mixture was foamed for 30 minutes by allowing nitrogen gas to pass through the mixture. After 3 hours, 0.16 g of a 2,2′-azobisisobutyronitrile radical initiator dissolved in 10 mL of ethanol was added to the mixture, and the temperature thereof was increased to 75° C. The radical polymerization was allowed to proceed for 5 hours, and 3 mL of 1,1,1,3,3,3-hexamethyldisilazane was added to the mixture. The reaction was allowed to further proceed for additional 3 hours. The final mixture was filtered through a 170 mesh sieve to remove the coagulation material, and the dispersion liquid was dried in a Pyrex (registered trademark) dish at 120° C. overnight, thereby obtaining composite particles 22. The physical properties of the obtained composite particles 22 are listed in Table 1.

### Production Example of Composite Particles 23

Composite particles 23 were obtained in the same manner as in the production example of the composite particles 1 except that 5.0 g of a polyester resin fine particle dispersion liquid (resin fine particle solid content: 30% by mass, particle diameter of 40 nm) was used in place of 5.0 g of the colloidal silica dispersion liquid A in the item (2) of 1. Hydrolysis and polycondensation step described above. The physical properties of the obtained composite particles 23 are listed in Table 1.

TABLE 1

| | Fine particles A | | | | Fine particles B | | |
|---|---|---|---|---|---|---|---|
| Composite | | Configuration | | | | Young's | Embedding |
| particles | | ratio | | | | modulus | ratio |
| No. | Component | Pa | Pb | Pc | Component | GPa | % |
| Composite | Organic silicon | 0.40 | 0.00 | 0.60 | Silica | 70 | 60 |
| particles 1 | compound | | | | | | |
| Composite | Organic silicon | 0.65 | 0.00 | 0.35 | Silica | 70 | 60 |
| particles 2 | compound | | | | | | |
| Composite | Organic silicon | 0.35 | 0.00 | 0.65 | Silica | 70 | 60 |
| particles 3 | compound | | | | | | |
| Composite | Organic silicon | 0.30 | 0.00 | 0.70 | Silica | 70 | 60 |
| particles 4 | compound | | | | | | |
| Composite | Organic silicon | 0.20 | 0.00 | 0.80 | Silica | 70 | 60 |
| particles 5 | compound | | | | | | |
| Composite | Organic silicon | 0.30 | 0.50 | 0.20 | Silica | 70 | 60 |
| particles 6 | compound | | | | | | |
| Composite | Organic silicon | 0.00 | 1.00 | 0.00 | Silica | 70 | 60 |
| particles 7 | compound | | | | | | |
| Composite | Organic silicon | 0.40 | 0.00 | 0.60 | Silica | 70 | 60 |
| particles 8 | compound | | | | | | |
| Composite | Organic silicon | 0.40 | 0.00 | 0.60 | Silica | 70 | 60 |
| particles 9 | compound | | | | | | |
| Composite | Organic silicon | 0.40 | 0.00 | 0.60 | Silica | 70 | 60 |
| particles 10 | compound | | | | | | |
| Composite | Organic silicon | 0.40 | 0.00 | 0.60 | Silica | 70 | 60 |
| particles 11 | compound | | | | | | |
| Composite | Organic silicon | 0.40 | 0.00 | 0.60 | Titanium | 150 | 60 |
| particles 12 | compound | | | | oxide | | |
| Composite | Organic silicon | 0.40 | 0.00 | 0.60 | Silica | 70 | 40 |
| particles 13 | compound | | | | | | |
| Composite | Organic silicon | 0.40 | 0.00 | 0.60 | Silica | 70 | 57 |
| particles 14 | compound | | | | | | |
| Composite | Organic silicon | 0.40 | 0.00 | 0.60 | Silica | 70 | 50 |
| particles 15 | compound | | | | | | |
| Composite | Organic silicon | 0.40 | 0.00 | 0.60 | Silica | 70 | 53 |
| particles 16 | compound | | | | | | |
| Composite | Organic silicon | 0.40 | 0.00 | 0.60 | Silica | 70 | 40 |
| particles 17 | compound | | | | | | |
| Composite | Organic silicon | 0.40 | 0.00 | 0.60 | Silica | 70 | 100 |
| particles 18 | compound | | | | | | |
| Composite | Organic silicon | 0.40 | 0.00 | 0.60 | Silica | 70 | 15 |
| particles 19 | compound | | | | | | |
| Composite | Organic silicon | 0.80 | 0.00 | 0.20 | Silica | 70 | 60 |
| particles 20 | compound | | | | | | |
| Composite | Organic silicon | 0.40 | 0.00 | 0.60 | Silica | 70 | 60 |
| particles 21 | compound | | | | | | |
| Composite | Acrylic resin | — | — | — | Silica | 70 | 60 |
| particles 22 | | | | | | | |
| Composite | Organic silicon | 0.40 | 0.00 | 0.60 | Polyester | 20 | 60 |
| particles 23 | compound | | | | | | |

| | | Particle | | True | |
|---|---|---|---|---|---|
| Composite | | diameter | Young's | specific | |
| particles | | Da | modulus | gravity | |
| No. | Bc/Ac | μm | GPa | g/cm³ | Surface treatment |
| Composite | 0.30 | 0.12 | 15 | 1.35 | Hexamethyldisilazane |
| particles 1 | | | | | |
| Composite | 0.30 | 0.12 | 30 | 1.35 | Hexamethyldisilazane |
| particles 2 | | | | | |
| Composite | 0.30 | 0.12 | 10 | 1.35 | Hexamethyldisilazane |
| particles 3 | | | | | |
| Composite | 0.30 | 0.12 | 8 | 1.35 | Hexamethyldisilazane |
| particles 4 | | | | | |
| Composite | 0.30 | 0.12 | 5 | 1.35 | Hexamethyldisilazane |
| particles 5 | | | | | |
| Composite | 0.30 | 0.12 | 15 | 1.35 | Hexamethyldisilazane |
| particles 6 | | | | | |
| Composite | 0.30 | 0.12 | 12 | 1.35 | Hexamethyldisilazane |
| particles 7 | | | | | |
| Composite | 0.30 | 0.12 | 15 | 1.35 | Octamethylcyclofefrasiloxane |
| particles 8 | | | | | |
| Composite | 0.30 | 0.12 | 15 | 1.35 | None |
| particles 9 | | | | | |
| Composite | 0.30 | 0.12 | 23 | 1.60 | Hexamethyldisilazane |
| particles 10 | | | | | |
| Composite | 0.30 | 0.12 | 26 | 1.70 | Hexamethyldisilazane |
| particles 11 | | | | | |
| Composite | 0.30 | 0.12 | 28 | 1.50 | Hexamethyldisilazane |
| particles 12 | | | | | |
| Composite | 0.05 | 0.11 | 15 | 1.35 | Hexamethyldisilazane |
| particles 13 | | | | | |
| Composite | 0.70 | 0.16 | 15 | 1.35 | Hexamethyldisilazane |
| particles 14 | | | | | |
| Composite | 0.03 | 0.11 | 15 | 1.35 | Hexamethyldisilazane |
| particles 15 | | | | | |
| Composite | 0.75 | 0.17 | 15 | 1.35 | Hexamethyldisilazane |
| particles 16 | | | | | |
| Composite | 0.75 | 0.19 | 15 | 1.35 | Hexamennyidisilazane |
| particles 17 | | | | | |
| Composite | 0.30 | 0.10 | 15 | 1.35 | Hexamethyldisilazane |
| particles 18 | | | | | |
| Composite | 0.30 | 0.15 | 15 | 1.35 | Hexamethyldisitazane |
| particles 19 | | | | | |
| Composite | 0.30 | 0.12 | 32 | 1.35 | Hexamethyldisilazane |
| particles 20 | | | | | |
| Composite | 0.38 | 0.10 | 15 | 1.35 | Hexamethyldisilazane |
| particles 21 | | | | | |
| Composite | 0.30 | 0.12 | 40 | 2.50 | None |
| particles 22 | | | | | |
| Composite | 0.40 | 0.12 | 13 | 1.35 | Hexamethyldisilazane |
| particles 23 | | | | | |

### Production Example of Silica Fine Particles 1

Oxygen gas and hydrogen gas were supplied to form a flame, and silicon tetrachloride which was a raw material was added thereto for gasification, thereby obtaining silica fine particles. The obtained silica fine particles were transferred to an electric furnace, spread in a thin layer, and sintered by being subjected to a heat treatment at 900° C. Thereafter, the resultant was subjected to a surface treatment with hexamethyldisilazane as the hydrophobic treatment, thereby obtaining silica fine particles 1. The physical properties of the obtained silica fine particles 1 are listed in Table 2.

### Production Examples of Silica Fine Particles 2 to 4

Silica fine particles 2 to 4 were obtained by adjusting the addition amount of silicon tetrachloride, the supply amount of oxygen gas, the supply amount of hydrogen gas, the concentration of silica fine particles, the retention time, the temperature and the time for sintering, and the kind of the surface treatment agent. The physical properties of the obtained silica fine particles 2 to 4 are listed in Table 2.

### Production Examples of Silica Fine Particles 5

Silica fine particles 5 were obtained in the same manner as in the production example of the silica fine particles 1 except that the hydrophobizing agent used was changed to chloromethylsilane. The physical properties of the obtained silica fine particles 5 are listed in Table 2.

### Production Examples of Silica Fine Particles 6

Silica fine particles 6 were obtained in the same manner as in the production example of the silica fine particles 1 except that the hydrophobizing agent used was not used. The physical properties of the obtained silica fine particles 6 are listed in Table 2.

TABLE 2

| | Particle diameter Db | |
|---|---|---|
| Silica fine particles No. | μm | Surface treatment |
| Silica fine particles 1 | 0.10 | Hexamethyldisilazane |
| Silica fine particles 2 | 0.12 | Hexamethyldisilazane |
| Silica fine particles 3 | 0.35 | Hexamethyldisilazane |
| Silica fine particles 4 | 0.02 | Hexamethyldisilazane |
| Silica fine particles 5 | 0.10 | Chlorotrimethylsilane |
| Silica fine particles 6 | 0.10 | None |

### Production Example of Polyester Resin A1

Polyoxypropylene (2.2)-2,2-bis(4-hydroxyphenyl) propane: 76.9 parts (0.167 moles)
Terephthalic acid (TPA): 25.0 parts (0.145 moles)
Adipic acid: 8.0 parts (0.054 moles)
Titanium tetrabutoxide: 0.5 parts

The above-described materials were placed in a 4 L four-necked glass flask, and a thermometer, a stirring rod, a condenser, and a nitrogen introduction tube were attached to the flask and placed in a mantle heater. Next, the inside of the flask was substituted with nitrogen gas and gradually heated while the mixture was stirred, and the mixture was allowed to react for 4 hours while being stirred at a temperature of 200° C. (first reaction step). Thereafter, 1.2 parts (0.006 moles) of trimellitic anhydride (TMA) was added thereto, and the mixture was allowed to react at 180° C. for 1 hour (second reaction step), thereby obtaining a polyester resin A1 serving as a binder resin component. The acid value of the polyester resin A1 was 5 mgKOH/g.

### Production Example of Polyester Resin A2

Polyoxypropylene (2.2)-2,2-bis(4-hydroxyphenyl) propane: 71.3 parts (0.155 moles)
Terephthalic acid: 24.1 parts (0.145 moles)
Titanium tetrabutoxide: 0.6 parts

The above-described materials were placed in a 4 L four-necked glass flask, and a thermometer, a stirring rod, a condenser, and a nitrogen introduction tube were attached to the flask and placed in a mantle heater. Next, the inside of the flask was substituted with nitrogen gas and gradually heated while the mixture was stirred, and the mixture was allowed to react for 2 hours while being stirred at a temperature of 200° C. Thereafter, 5.8 parts (0.030% by mole) of trimellitic anhydride was added thereto, and the mixture was allowed to react at 180° C. for 10 hours, thereby obtaining a polyester resin A2. The acid value of the polyester resin A2 was 10 mgKOH/g.

### Production Example of Toner Particles 1

Polyester resin A1:70.0 parts
Polyester resin A2:30.0 parts
Fischer-Tropsch wax (peak temperature of maximum endothermic peak: 78° C.): 5.0 parts
C.I. Pigment Blue 15:3:5.0 parts
3.5-di-t-butylsalicylic acid aluminum compound: 0.1 parts

The raw materials shown in the above-described formulation were mixed at a rotation speed of 20 s⁻¹ for a rotation time of 5 minutes using a Henschel mixer (FM-75 model, manufactured by NIPPON COKE & ENGINEERING CO., LTD.) and kneaded by a twin screw kneader (PCM-30 model, manufactured by IKEGAI CO., LTD.) set at a temperature of 125° C. and a rotation speed of 300 rpm. The obtained kneaded material was cooled, coarsely pulverized to a diameter of 1 mm or less using a hammer mill to obtain a coarsely pulverized material. The obtained coarsely pulverized material was finely pulverized using a mechanical pulverizer (T-250, manufactured by FREUND-TURBO CORPORATION). Further, classification was performed using a rotary classifier (200TSP, manufactured by Hosokawa Micron Corporation), thereby obtaining toner particles 1. The rotary classifier was operated under a condition of a classification rotor rotation speed of 50.0 s-1. The obtained toner particles 1 had a weight-average molecular weight (D4) of 5.9 μm.

### Production Example of Toner 1

Toner particles 1:100 parts
Composite particles 1:2.0 parts
Silica fine particles 1:2.0 parts

The above-described materials were mixed at a rotation speed of 30 s-1 for a rotation time of 10 min using a Henschel mixer FM-10c model (manufactured by Mitsui Mike Kakoki Co., Ltd.), thereby obtaining a toner 1.

### Production Examples of Toners 2 to 35

Toners 2 to 35 were obtained by performing production in the same manner as described above except that the kinds and the addition amounts of the composite particles and the silica fine particles were changed as listed in Table 3 in the production example of the toner 1. The physical properties of the toners 2 to 35 are listed in Table 3.

TABLE 3

| | | Composite particles | Addition amount | Silica fine particles | Addition amount | | |
|---|---|---|---|---|---|---|---|
| Toner No. | Toner particles No. | No. | (parts by mass) | No. | (parts by mass) | Da/Db | Dc/Db |
| Toner 1 | Toner particles 1 | Composite particles | 2.0 | Silica fine particles | 2.0 | 1.2 | 0.12 |
| | | 1 | | 1 | | | |
| Toner 2 | Toner particles 1 | Composite particles | 2.0 | Silica fine particles | 2.0 | 1.2 | 0.12 |
| | | 2 | | 1 | | | |
| Toner 3 | Toner particles 1 | Composite particles | 2.0 | Silica fine particles | 2.0 | 1.2 | 0.12 |
| | | 3 | | 1 | | | |
| Toner 4 | Toner particles 1 | Composite particles | 2.0 | Silica fine particles | 2.0 | 1.2 | 0.12 |
| | | 4 | | 1 | | | |
| Toner 5 | Toner particles 1 | Composite particles | 2.0 | Silica fine particles | 2.0 | 1.2 | 0.12 |
| | | 5 | | 1 | | | |
| Toner 6 | Toner particles 1 | Composite particles | 2.0 | Silica fine particles | 2.0 | 1.2 | 0.12 |
| | | 6 | | 1 | | | |
| Toner 7 | Toner particles 1 | Composite particles | 2.0 | Silica fine particles | 2.0 | 1.2 | 0.12 |
| | | 7 | | 1 | | | |
| Toner 8 | Toner particles 1 | Composite particles | 2.0 | Silica fine particles | 2.0 | 1.2 | 0.12 |
| | | 8 | | 5 | | | |
| Toner 9 | Toner particles 1 | Composite particles | 2.0 | Silica fine particles | 2.0 | 1.2 | 0.12 |
| | | 8 | | 1 | | | |
| Toner 10 | Toner particles 1 | Composite particles | 2.0 | Silica fine particles | 2.0 | 1.2 | 0.12 |
| | | 9 | | 6 | | | |
| Toner 11 | Toner particles 1 | Composite particles | 2.0 | Silica fine particles | 2.0 | 1.2 | 0.12 |
| | | 10 | | 1 | | | |
| Toner 12 | Toner particles 1 | Composite particles | 2.0 | Silica fine particles | 2.0 | 1.2 | 0.12 |
| | | 11 | | 1 | | | |
| Toner 13 | Toner particles 1 | Composite particles | 2.0 | Silica fine particles | 2.0 | 1.2 | 0.12 |
| | | 12 | | 1 | | | |
| Toner 14 | Toner particles 1 | Composite particles | 0.3 | Silica fine particles | 3.0 | 1.2 | 0.12 |
| | | 1 | | 1 | | | |
| Toner 15 | Toner particles 1 | Composite particles | 3.0 | Silica fine particles | 0.3 | 1.2 | 0.12 |
| | | 1 | | 1 | | | |
| Toner 16 | Toner particles 1 | Composite particles | 0.1 | Silica fine particles | 2.0 | 1.2 | 0.12 |
| | | 1 | | 1 | | | |
| Toner 17 | Toner particles 1 | Composite particles | 2.0 | Silica fine particles | 0.1 | 1.2 | 0.12 |
| | | 1 | | 1 | | | |
| Toner 18 | Toner particles 1 | Composite particles | 1.0 | Silica fine particles | 20.0 | 1.2 | 0.12 |
| | | 1 | | 1 | | | |
| Toner 19 | Toner particles 1 | Composite particles | 20.0 | Silica fine particles | 1.0 | 1.2 | 0.12 |
| | | 1 | | 1 | | | |
| Toner 20 | Toner particles 1 | Composite particles | 0.08 | Silica fine particles | 0.08 | 1.2 | 0.12 |
| | | 1 | | 1 | | | |
| Toner 21 | Toner particles 1 | Composite particles | 25.0 | Silica fine particles | 25.0 | 1.2 | 0.12 |
| | | 1 | | 1 | | | |
| Toner 22 | Toner particles 1 | Composite particles | 2.0 | Silica fine particles | 2.0 | 1.2 | 0.03 |
| | | 13 | | 1 | | | |
| Toner 23 | Toner particles 1 | Composite particles | 2.0 | Silica fine particles | 2.0 | 1.3 | 0.25 |
| | | 14 | | 2 | | | |
| Toner 24 | Toner particles 1 | Composite particles | 2.0 | Silica fine particles | 2.0 | 1.1 | 0.02 |
| | | 15 | | 1 | | | |
| Toner 25 | Toner particles 1 | Composite particles | 2.0 | Silica fine particles | 2.0 | 1.4 | 0.29 |
| | | 16 | | 2 | | | |
| Toner 26 | Toner particles 1 | Composite particles | 2.0 | Silica fine particles | 2.0 | 1.6 | 0.37 |
| | | 17 | | 2 | | | |
| Toner 27 | Toner particles 1 | Composite particles | 2.0 | Silica fine particles | 2.0 | 1.0 | 0.00 |
| | | 18 | | 1 | | | |
| Toner 28 | Toner particles 1 | Composite particles | 2.0 | Silica fine particles | 2.0 | 1.5 | 0.26 |
| | | 19 | | 1 | | | |
| Toner 29 | Toner particles 1 | Composite particles | 2.0 | Silica fine particles | 2.0 | 1.2 | 0.12 |
| | | 20 | | 1 | | | |
| Toner 30 | Toner particles 1 | Composite particles | 2.0 | Silica fine particles | 2.0 | 0.3 | 0.03 |
| | | 21 | | 3 | | | |
| Toner 31 | Toner particles 1 | Composite particles | 2.0 | Silica fine particles | 2.0 | 5.0 | 0.60 |
| | | 21 | | 4 | | | |
| Toner 32 | Toner particles 1 | Composite particles | 2.0 | Silica fine particles | 2.0 | 1.2 | 0.12 |
| | | 22 | | 1 | | | |
| Toner 33 | Toner particles 1 | Composite particles | 2.0 | Silica fine particles | 2.0 | 1.2 | 0.16 |
| | | 23 | | 1 | | | |
| Toner 34 | Toner particles 1 | Composite particles | 2.0 | — | — | — | — |
| | | 1 | | | | | |
| Toner 35 | Toner particles 1 | — | — | Silica fine particles | 2.0 | — | — |
| | | | | 1 | | | |

### Production Example of Carrier 1

Magnetite 1 with number average particle diameter of 0.30 μm (magnetization strength of 65 Am²/kg in magnetic field of 1000/4π (kA/m))
Magnetite 2 with number average particle diameter of 0.50 μm (magnetization strength of 65 Am²/kg in magnetic field of 1000/4π (kA/m))

4.0 parts of a silane compound (3-(2-aminoethylaminopropyl) trimethoxysilane) was added to 100 parts of each of the above-described materials, the mixture was mixed and stirred in a container at 100° C. or higher at a high speed to treat each of fine particles.
Phenol: 10% by mass
Formaldehyde solution: 6% by mass (40% by mass of formaldehyde, 10% by mass of methanol, 50% by mass of water)
Magnetite 1 treated with silane compound described above: 58% by mass
Magnetite 2 treated with silane compound described above: 26% by mass

100 parts of the above-described materials, 5 parts of a 28 mass % ammonia aqueous solution, and 20 parts of water were placed in a flask, heated to 85° C. and maintained at the temperature for 30 minutes while being stirred and mixed, and subjected to a polymerization reaction for 3 hours to cure a phenol resin generated. Thereafter, the cured phenol resin was cooled to 30° C., water was further added thereto, the supernatant was removed, and the precipitate was washed with water and air-dried. Next, the resultant was dried at a temperature of 60° C. under reduced pressure (5 mmHg or less), thereby obtaining a spherical magnetic material dispersed carrier 1. The 50% particle diameter (D50) thereof on a volume basis was 34.2 μm.

### Production Example of Two-Component Developer 1

8.0 parts of the toner 1 was added with respect to 92.0 parts of the carrier 1, and the mixture was mixed with a V type mixer (V-20, manufactured by SEISHIN ENTERPRISE Co., Ltd.), thereby obtaining a two-component developer 1.

### Production Examples of Two-Component Developers 2 to 35

Two-component developers 2 to 35 were obtained by performing production in the same manner as described above except that the toner was changed as listed in Table 4 in the production example of the two-component developer 1.

TABLE 4

| Two-component developer No. | Toner No. | Carrier No. |
|---|---|---|
| Two-component developer 1 | Toner 1 | Carrier 1 |
| Two-component developer 2 | Toner 2 | Carrier 1 |
| Two-component developer 3 | Toner 3 | Carrier 1 |
| Two-component developer 4 | Toner 4 | Carrier 1 |
| Two-component developer 5 | Toner 5 | Carrier 1 |
| Two-component developer 6 | Toner 6 | Carrier 1 |
| Two-component developer 7 | Toner 7 | Carrier 1 |
| Two-component developer 8 | Toner 8 | Carrier 1 |
| Two-component developer 9 | Toner 9 | Carrier 1 |
| Two-component developer 10 | Toner 10 | Carrier 1 |
| Two-component developer 11 | Toner 11 | Carrier 1 |
| Two-component developer 12 | Toner 12 | Carrier 1 |
| Two-component developer 13 | Toner 13 | Carrier 1 |
| Two-component developer 14 | Toner 14 | Carrier 1 |
| Two-component developer 15 | Toner 15 | Carrier 1 |
| Two-component developer 16 | Toner 16 | Carrier 1 |
| Two-component developer 17 | Toner 17 | Carrier 1 |
| Two-component developer 18 | Toner 18 | Carrier 1 |
| Two-component developer 19 | Toner 19 | Carrier 1 |
| Two-component developer 20 | Toner 20 | Carrier 1 |
| Two-component developer 21 | Toner 21 | Carrier 1 |
| Two-component developer 22 | Toner 22 | Carrier 1 |
| Two-component developer 23 | Toner 23 | Carrier 1 |
| Two-component developer 24 | Toner 24 | Carrier 1 |
| Two-component developer 25 | Toner 25 | Carrier 1 |
| Two-component developer 26 | Toner 26 | Carrier 1 |
| Two-component developer 27 | Toner 27 | Carrier 1 |
| Two-component developer 28 | Toner 28 | Carrier 1 |
| Two-component developer 29 | Toner 29 | Carrier 1 |
| Two-component developer 30 | Toner 30 | Carrier 1 |
| Two-component developer 31 | Toner 31 | Carrier 1 |
| Two-component developer 32 | Toner 32 | Carrier 1 |
| Two-component developer 33 | Toner 33 | Carrier 1 |
| Two-component developer 34 | Toner 34 | Carrier 1 |
| Two-component developer 35 | Toner 35 | Carrier 1 |

### Examples 1 to 26 and Comparative Examples 1 to 9

### Method of Evaluating Toner

The developers 1 to 35 obtained above were evaluated as follows.

In the evaluation, a color copying machine imagePRESS C850 (manufactured by CANON INC.) or a modified machine thereof was used as an image forming apparatus.

Each developer was placed in a developing device of a station for a cyan color of an image forming apparatus, and the dot reproducibility before and after paper feeding durability test was performed.

The dot reproducibility was evaluated by performing a paper feeding durability test in a printing environment (hereinafter, referred to as “N/L environment”) of a temperature of 23° C. and a relative humidity of 5% and forming 10000 sheets of images using a test charge with an image ratio of 5%

### Conditions for Paper Feeding Durability Test in Evaluation of Dot Reproducibility:

Paper: recycled paper for copying, GF-R₁₀₀W (A4, basis weight of 67 g/m², sod by Canon Marketing Japan Inc.)
Image forming speed: A4 size, full color, 85 sheets/min
Development conditions: Modification was made such that the development contrast was adjustable to any value, and automatic correction was not operated by the main body.

### Dot Reproducibility

The dot reproducibility was evaluated as follows before and after the paper feeding durability test. Halftone (30h) images were formed, and the evaluation was performed according to the following criteria. Further, the 30h image denotes a halftone image in which the 256 gradations are expressed in hexadecimal, 00h is defined as solid white (non-image), and FFh is defined as a solid image (full image). The areas of 1000 dots of the image were measured using a digital microscope VHX-500 (wide-range zoom lens VH-Z100, manufactured by KEYENCE CORPORATION). The number average(S) of the dot areas and the standard deviation (6) of the dot areas were calculated, and the dot reproducibility index was calculated by the following equation.

$$Dot reproducibility index = σ / S \times 100$$

The dot reproducibility was evaluated based on the dot reproducibility index of the halftone image. The dot reproducibility is excellent as the value of the dot reproducibility index decreases. A rank of G or higher was determined to indicate that the effects of the present disclosure were obtained. The evaluation results are listed in Table 5.

### Evaluation Criteria

A: The dot reproducibility was less than 1.0.
B: The dot reproducibility was 1.0 or greater and less than 2.0.
C: The dot reproducibility was 2.0 or greater and less than 3.0.
D: The dot reproducibility was 3.0 or greater and less than 4.0.
E: The dot reproducibility was 4.0 or greater and less than 5.0.
F: The dot reproducibility was 5.0 or greater and less than 6.0.
G: The dot reproducibility was 6.0 or greater and less than 7.0.
H: The dot reproducibility was 7.0 or greater.

TABLE 5

| | | Dot reproducibility at | | Dot reproducibility after | |
|---|---|---|---|---|---|
| | | initial stage | | endurance | |
| | Two-component developer | Dot reproducibility | | Dot reproducibility | |
| | No. | index | Rank | index | Rank |
| Example 1 | Two-component developer 1 | 0.8 | A | 0.9 | A |
| Example 2 | Two-component developer 2 | 0.8 | A | 1.4 | B |
| Example 3 | Two-component developer 3 | 0.8 | A | 1.5 | B |
| Example 4 | Two-component developer 4 | 0.8 | A | 2.1 | C |
| Example 5 | Two-component developer 5 | 0.9 | A | 3.3 | D |
| Example 6 | Two-component developer 6 | 0.8 | A | 1.1 | B |
| Example 7 | Two-component developer 7 | 0.8 | A | 1.2 | B |
| Example 8 | Two-component developer 8 | 1.7 | B | 1.9 | B |
| Example 9 | Two-component developer 9 | 2.3 | C | 2.4 | C |
| Example 10 | Two-component developer 10 | 2.5 | C | 2.6 | C |
| Example 11 | Two-component developer 11 | 1.7 | B | 2.8 | C |
| Example 12 | Two-component developer 12 | 1.8 | B | 3.2 | D |
| Example 13 | Two-component developer 13 | 2.8 | C | 2.9 | C |
| Example 14 | Two-component developer 14 | 2.7 | C | 2.9 | C |
| Example 15 | Two-component developer 15 | 3.5 | D | 3.5 | D |
| Example 16 | Two-component developer 16 | 3.2 | D | 3.5 | D |
| Example 17 | Two-component developer 17 | 4.2 | E | 4.2 | E |
| Example 18 | Two-component developer 18 | 4.2 | E | 4.6 | E |
| Example 19 | Two-component developer 19 | 5.3 | F | 5.3 | F |
| Example 20 | Two-component developer 20 | 6.5 | G | 6.8 | G |
| Example 21 | Two-component developer 21 | 5.7 | F | 5.9 | F |
| Example 22 | Two-component developer 22 | 4.5 | E | 4.7 | E |
| Example 23 | Two-component developer 23 | 4.7 | E | 4.7 | E |
| Example 24 | Two-component developer 24 | 5.1 | F | 5.3 | F |
| Example 25 | Two-component developer 25 | 5.2 | F | 5.3 | F |
| Example 26 | Two-component developer 26 | 6.5 | G | 6.7 | G |
| Comparative Example 1 | Two-component developer 27 | 7.1 | H | 7.2 | H |
| Comparative Example 2 | Two-component developer 28 | 4.8 | E | 7.8 | H |
| Comparative Example 3 | Two-component developer 29 | 1.2 | B | 8.0 | H |
| Comparative Example 4 | Two-component developer 30 | 7.5 | H | 7.8 | H |
| Comparative Example 5 | Two-component developer 31 | 8.1 | H | 8.2 | H |
| Comparative Example 6 | Two-component developer 32 | 2.1 | C | 7.2 | H |
| Comparative Example 7 | Two-component developer 33 | 7.2 | H | 8.5 | H |
| Comparative Example 8 | Two-component developer 34 | 8.9 | H | 9.2 | H |
| Comparative Example 9 | Two-component developer 35 | 7.3 | H | 9.2 | H |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-173999, filed Oct. 6, 2023, which is hereby incorporated by reference herein in its entirety.

What is claimed is:

1. A toner comprising:
a toner particle;
a composite particle present on a surface of the toner particle; and
a spherical silica fine particle,
wherein the composite particle includes a fine particle A containing, as a binder component, an organic silicon compound that has a siloxane bond, and a fine particle B which is an inorganic fine particle,
wherein the fine particle B is present on a surface of the composite particle in a state where a part of the fine particle B is embedded in a surface of the fine particle A,
wherein Da is a number average particle diameter of the composite particle, and Db is a number average particle diameter of the spherical silica fine particle,
wherein Db is 0.03 μm or greater and 0.30 μm or less, and 0.4≤Da/Db≤1.8 is satisfied,
wherein Pa is a proportion of a silicon atom represented by Si^{a} in a structure represented by a unit (a), Pb is a proportion of a silicon atom represented by Si^{b} in a structure represented by a unit (b), and Pc is a proportion of a silicon atom represented by Si^{c} in a structure represented by a unit (c) based on all silicon atoms contained in the organic silicon compound of the fine particle A, and
wherein Pa, Pb, and Pc satisfy Expressions (1) to (3),
$$Pa + Pb + Pc \geq 0 \text{.80} \qquad ( 1 )$$
$$Pb + Pc \geq 0 \text{.30} \qquad ( 2 )$$
$$Pa \leq 0.7 \qquad ( 3 )$$ 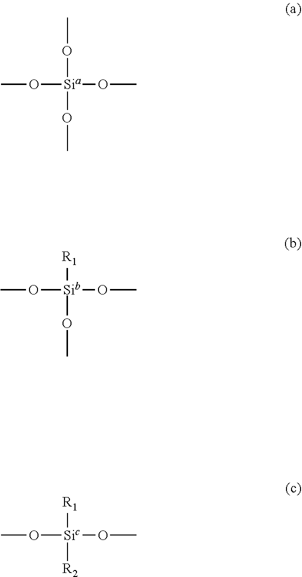
wherein R₁ and R₂ represent an alkyl group having 1 or more and 6 or less carbon atoms, and
wherein an average value of embedding ratios of the fine particle B represented by the following equation to the fine particle A in the composite particle is 30% or greater and 90% or less,
embedding ratio (%) of fine particleBto fine particleA=(depth of fine particleBembedded in fine particleA/diameter of fine particleB)×100.

2. The toner according to claim 1,
wherein Dc is an average height of portions of the fine particle B protruding from the fine particle A, and 0.03≤Dc/Db≤0.30 is satisfied.

3. The toner according to claim 1,
wherein A_{D} is a number average particle diameter of a primary particle of the fine particle A, B_{D} is a number average particle diameter of a primary particle of the fine particle B, and a ratio B_{D}/A_{D} is 0.05 or greater and 0.70 or less.

4. The toner according to claim 1,
wherein the fine particle B has a Young's modulus of 50 GPa or greater.

5. The toner according to claim 1,
wherein a content of the composite particle is 0.1 parts by mass or greater and 20.0 parts by mass or less with respect to 100 parts by mass of the toner particle.

6. The toner according to claim 1,
wherein a content of the spherical silica fine particle is 0.1 parts by mass or greater and 20.0 parts by mass or less with respect to 100 parts by mass of the toner particle.

7. The toner according to claim 1,
wherein a ratio (content of composite particle with respect to 100 parts by mass of toner particle)/(content of spherical silica fine particle with respect to 100 parts by mass of toner particle) is 0.2 or greater and 5.0 or less.

8. The toner according to claim 1,
wherein the fine particle B is silica.

9. The toner according to claim 1,
wherein the composite particle has a true specific gravity of 1.00 g/cm³ or greater and 1.60 g/cm³ or less.

10. The toner according to claim 1,
wherein both the composite particle and the spherical silica fine particle are subjected to a surface treatment with the same compound selected from the group consisting of an alkylsilazane compound, an alkylalkoxysilane compound, a chlorosilane compound, a siloxane compound, and silicone oil.

11. The toner according to claim 1,
wherein Pa, Pb, and Pc satisfy Expressions (I), (II), and (III).
$$0.3 \leq Pa / ( Pa + Pb + Pc ) \leq 0.7 \qquad ( I )$$
$$0 \leq Pb / ( Pa + Pb + Pc ) \leq 0.5 \qquad ( II )$$
$$0.2 \leq Pc / ( Pa + Pb + Pc ) \leq 0.7 . \qquad ( III )$$

12. The toner according to claim 1,
wherein the composite particle has a Young's modulus of 10 GPa or greater and 30 GPa or less.
